(19) United States
(12) Patent Application Publication
(10) Pub. No.: US 2012/0169711 A1
(43) Pub. Date: Jul. 5, 2012

(54) Method and apparatus for removing image artifacts in display related mode changes

(75) Inventors: Jani E. Penttila, Lempaala (FI); Juha H-P Nurmi, Salo (FI)

(73) Assignee: Nokia Corporation

(21) Appl. No.: 12/930,409

(22) Filed: Jan. 5, 2011

(51) Int. Cl. G06T 15/00; G09G 5/36

(52) U.S. Cl. 345/419; 345/545

(57) ABSTRACT

In accordance with an example embodiment of the present invention, a method is disclosed. A first image display mode is provided at a display of an apparatus. The first image display mode includes mapping first data from a display frame memory. The first data corresponds to the first image display mode. A second image display mode is provided at the display. The second image display mode includes mapping second data from the display frame memory. The second data corresponds to the second image display mode. The first image display mode is switched to the second image display mode when only a portion of the second data is detected at the display frame memory.

### TECHNICAL FIELD

The invention relates generally to removing image artifacts in a display.

### BACKGROUND

An electronic device typically comprises a variety of components and/or features that enable users to interact with the electronic device. Some considerations when providing these features in a portable electronic device may include, for example, compactness, suitability for mass manufacturing, durability, and ease of use. Increase of computing power of portable devices is turning them into versatile portable computers, which can be used for multiple different purposes. Therefore versatile components and/or features are needed in order to take full advantage of capabilities of mobile devices.

One area gaining popularity in the consumer market is the use of stereoscopic displays (or three-dimensional [3D] displays). Accordingly, as consumers demand increased functionality from the electronic device, there is a need to provide an improved device having increased capabilities, such as a three-dimensional display, while maintaining robust and reliable product configurations.

### SUMMARY

Various aspects of examples of the invention are set out in the claims.

According to a first aspect of the present invention, a method is disclosed. A first image display mode is provided at a display of an apparatus. The first image display mode includes mapping first data from a display frame memory. The first data corresponds to the first image display mode. A second image display mode is provided at the display. The second image display mode includes mapping second data from the display frame memory. The second data corresponds to the second image display mode. The first image display mode is switched to the second image display mode when only a portion of the second data is detected at the display frame memory.

According to a second aspect of the present invention, an apparatus is disclosed. The apparatus includes a display, at least one processor, and at least one memory. The display includes a plurality of left display pixels and a plurality of right display pixels. The at least one memory includes computer program code. The at least one memory and the computer program code are configured to, with the at least one processor, cause the apparatus to perform at least the following. Map left eye memory data to the plurality of left display pixels and to the plurality of right display pixels. Detect a predetermined amount of combined data in the memory. The combined data includes the left eye memory data and right eye memory data. Address the plurality of left and right display pixels separately from the left eye memory data and from the right eye memory data in response to the detected predetermined amount of combined data.

According to a third aspect of the present invention, a computer program product is disclosed. The computer program product includes a computer-readable medium bearing computer program code embodied therein for use with a computer, the computer program code includes code for accessing only a first portion of data in a memory. The first portion of data is configured to be mapped to left display pixels and to right display pixels of a display. Code for calculating an amount of combined data received in the memory. The combined data includes the first portion of the data and a second portion of the data. Code for addressing the left and right display pixels separately from the first and the second portions of the data after a predetermined amount of the combined data is received.

### BRIEF DESCRIPTION OF THE DRAWINGS

For a more complete understanding of example embodiments of the present invention, reference is now made to the following descriptions taken in connection with the accompanying drawings in which:

FIG. 1 is a front view of an electronic device incorporating features of the invention;

FIG. 2 is a partial section view of the device shown in FIG. 1 with a corresponding schematic diagram of the illustrated device components;

FIG. 3 is a diagram of one example embodiment of a layer functionality used in the device shown in FIG. 1;

FIG. 4 is a diagram of another example embodiment of a layer functionality used in the device shown in FIG. 1;

FIG. 5 is a diagram illustrating how input data from a storage is mapped to a display memory in the device shown in FIG. 1;

FIG. 6 is a diagram illustrating another example of how input data from a storage is mapped to a display memory in the device shown in FIG. 1;

FIG. 7 is a diagram illustrating how display memory data is mapped to a display panel of the device shown in FIG. 1;

FIG. 8 is a diagram illustrating how a 3D capable display memory is generally used to be copied on the panel of the device shown in FIG. 1 to show 2D data;

FIG. 9 is a diagram illustrating a portion of a line of 3D data at a display memory of the device shown in FIG. 1 and the corresponding user view at the display panel;

FIG. 10 is a diagram illustrating a first line (and a second line) of 3D data at the display memory of the device shown in FIG. 1 and the corresponding user view at the display panel;

FIG. 11 is a diagram illustrating the lines of 3D data at the display memory of the device shown in FIG. 1 and the corresponding user view at the display panel;

FIG. 12 a block diagram of an exemplary method of the device shown in FIG. 1; and

FIG. 13 is a schematic drawing illustrating components of the device shown in FIG. 1.

### DETAILED DESCRIPTION OF THE DRAWINGS

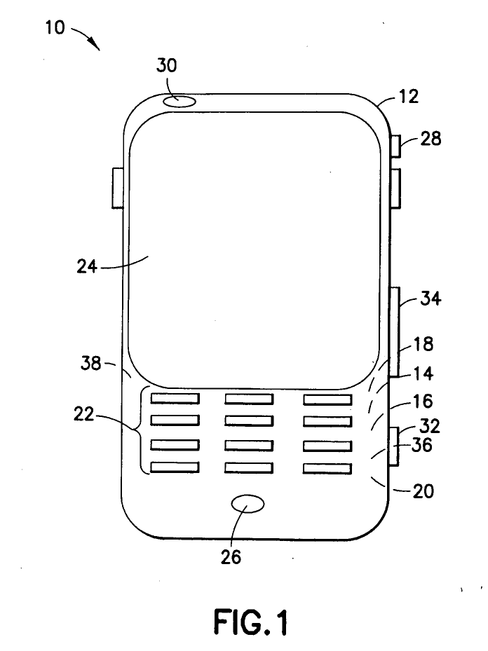

An example embodiment of the present invention and its potential advantages are understood by referring to FIGS. 1 through 13 of the drawings.

Referring to FIG. 1, there is shown a front view of an electronic device 10 incorporating features of the invention. Although the invention will be described with reference to the exemplary embodiments shown in the drawings, it should be understood that the invention can be embodied in many alternate forms of embodiments. In addition, any suitable size, shape or type of elements or materials could be used.

According to one example of the invention, the device 10 is a multi-function portable electronic device. However, in alternate embodiments, features of the various embodiments of the invention could be used in any suitable type of portable electronic device such as a mobile phone, a gaming device, a music player, a notebook computer, or a personal digital assistant, for example. In addition, as is known in the art, the device 10 can include multiple features or applications such as a camera, a music player, a game player, or an Internet browser, for example. The device 10 generally comprises a housing 12, a transmitter 14, a receiver 16, an antenna (connected to the transmitter 14 and the receiver 16), electronic circuitry 20, such as a controller (which could include a processor, for example) and a memory for example, within the housing 12, a user input region 22 and a display 24. The display 24 could also form a user input section, such as a touch screen.

The device (or user equipment) 10 may further comprise voice-recognition technology received at the microphone 26. Additionally, a power actuator 28 controls the device being turned on and off by the user. The exemplary device 10 may have a camera 30 which is shown as being forward facing (for example, for video calls) but may alternatively or additionally be rearward facing (for example, for capturing images and video for local storage). Additionally, the device may further comprise two forward facing camera and/or two rearward facing cameras, however, any suitable configuration may be provided. The camera 30 is controlled by a shutter actuator 32 and optionally by a zoom actuator 34 which may alternatively function as a volume adjustment for a speaker of the device when the camera 30 is not in an active mode. It should be noted these are provided as exemplary non-limiting features and that in alternate embodiments, the device 10 can have any suitable type of features as known in the art.

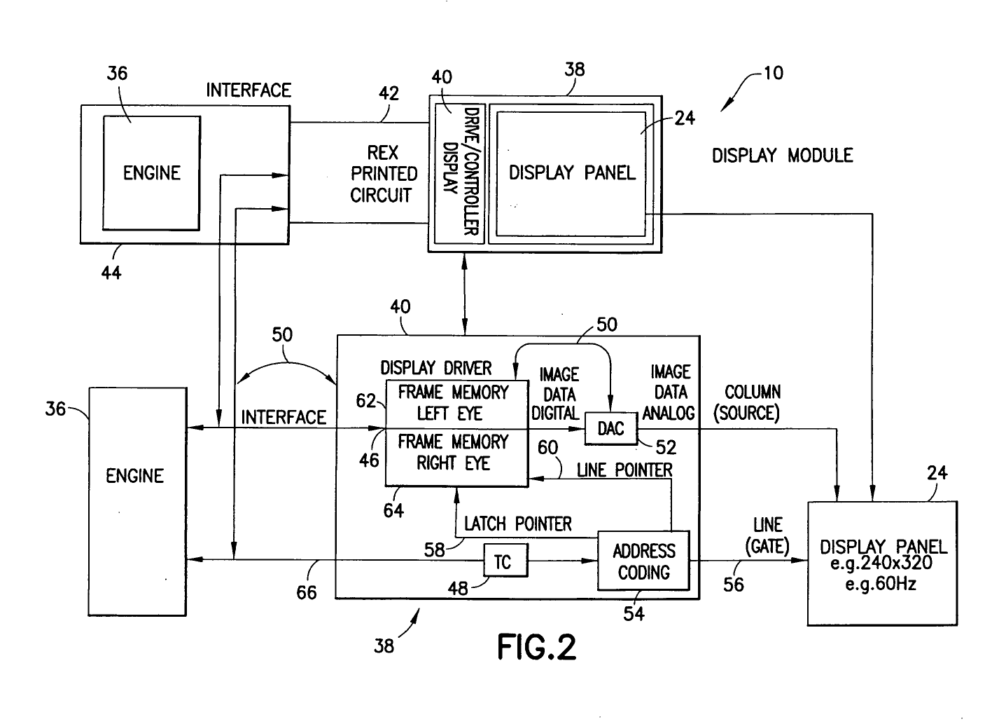

Referring now also to FIG. 2, a partial section view of the device 10 with a schematic diagram of the illustrated device components (shown with corresponding arrowhead lines therebetween) is shown. In particular, there is shown an engine 36 and a three-dimensional display module 38. The engine 36 generally controls various conversions of the device 10, such as converting electrical information to a readable format on the display 24, or converting audio from acoustic waves to an electrical format, for example. The engine 36 may comprise a controller (which could include a processor, for example). Additionally, according to some embodiments of the invention, more than one engine could be provided. The display module 38 includes the display (or display panel) 24 and a display driver/controller 40. The display 24 is a three-dimensional (3D) capable display comprising a quarter video graphics array (QVGA) having a 240×320 display resolution, for example. However, any suitable type of display may be provided.

In general, the three-dimensional display module 38 has similar properties when compared to two-dimensional displays, however, due to the three-dimensional display nature, additional data storage is generally used to store content separately for the left eye view and the right eye view.

According to some embodiments of the invention, a flex printed circuit 42 may be provided between the display module 38 and the engine 36. Additionally, the engine 36 may be provided on a printed wiring board 44 of the device 10. For example, one end of the flex printed circuit 42 may be connected to the display driver 40 and the other end of the flex printed circuit 42 may be connected to an interface of the printed wiring board 44. This provides for information load via the interface from the engine 36 to the display memory 46 of the display driver 40 to be independent of information updating on the display panel 24 from the display memory 46 of the display module 38 (wherein a timing controller (TC) 48 may be used, for example). This means that updating is asynchronized (see arrows 50). However, in alternate embodiments any suitable type connection between the display module 38 and the engine 36 may be provided. It should be noted that the display memory (or frame memory/display frame memory) 46 may be provided as any suitable type of memory, such as a random access memory (RAM), for example.

The display driver 40 may further comprise a digital to analog converter (DAC) 52, between the display panel 24 and the display memory (where the image data is stored) 46, for providing column (source) information converted from image data digital to image data analog. Additionally address coding 54 may be provided between the display panel 24 and the timing controller 48 for providing line (gate) information 56 to the display panel 24 and latch pointer 58 and line pointer 60 information to the display memory 46.

Some embodiments of the invention may comprise a sync signal line 66 between the timing controller 48 and the engine 36. The sync signal line 66 helps alleviate abnormal visual effects on the display panel 24 which can be caused by the asynchronized updating (see arrows 50). For example, a visual artifact may occur if the display memory 46 is updated from the engine 36, when simultaneously it is being updated to display panel 24. The sync signal line 66 provides an ‘artifact removal’ wherein the display updating position information has been sent to the engine 36 via the sync signal line 66.

Additionally, the three-dimensional (3D) display architecture comprises the display memory 46 as about double the size when compared to traditional two-dimensional (2D) display architectures. For example, as shown in FIG. 2, the display memory 46 comprises a left eye portion 62 and a right eye portion 64 to store information for left and right eye data separately. However, it should be noted that in alternate embodiments any suitable display memory may be provided. For example some embodiments may include ‘half resolution three-dimensional technologies’ which share the two-dimensional display RAM in a way that the memory size is not doubled (as described above), but instead the memory size saving is achieved via smaller resolutions in the three-dimensional mode.

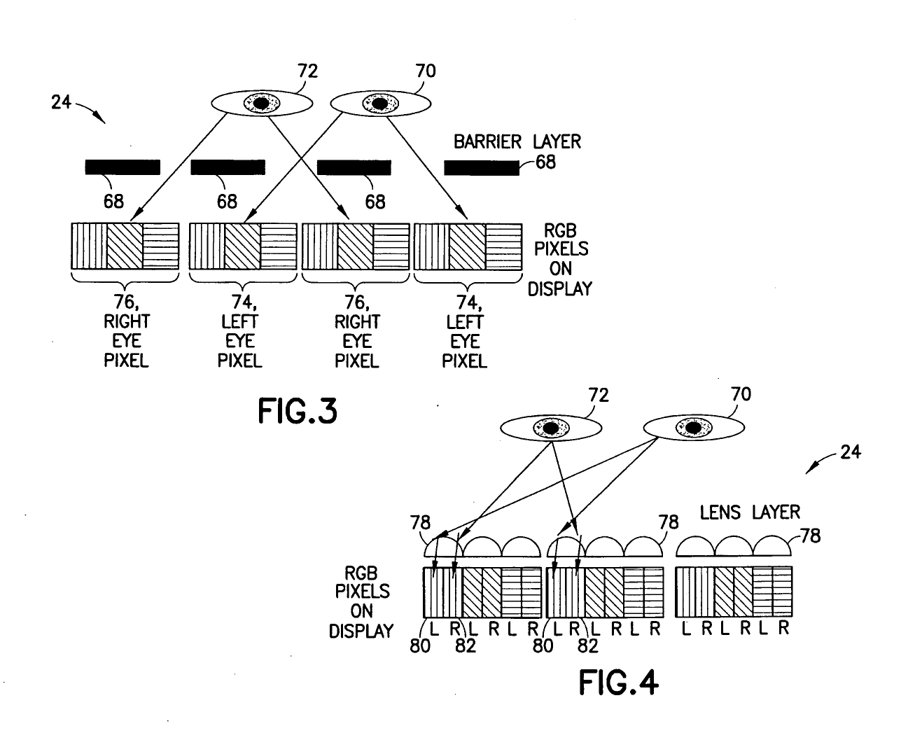

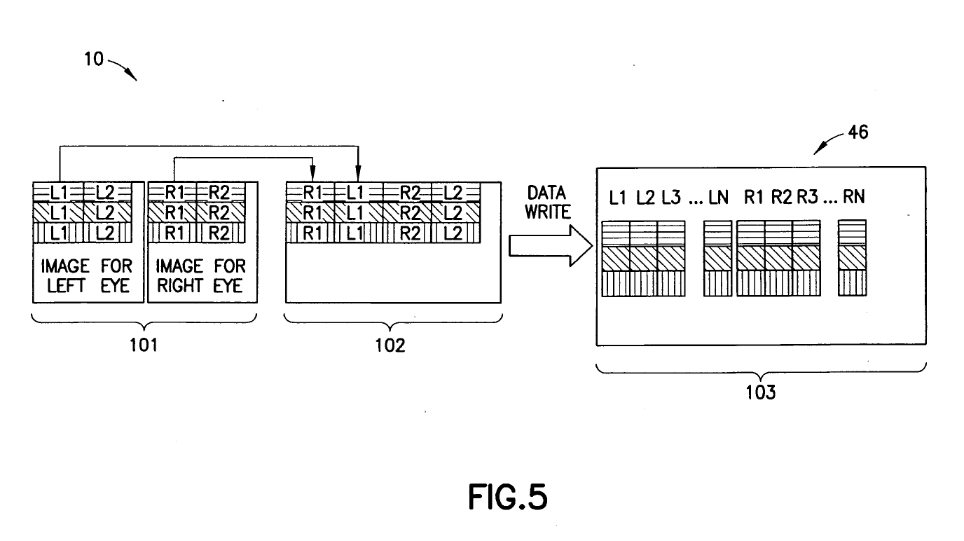

The left eye portion 62 of the display memory 46 and the right eye portion 64 of the display memory 46 are provided to the display panel 24 in a suitable configuration for a user of the device 10 to see a three-dimensional image. After the data is stored, and shown on the three-dimensional capable display panel 24, various techniques may be used to guide the light so that the left eye and the right eye see different content (for example, each eye sees a different image), which then creates a three-dimensional effect in the human brain. For example, some embodiments of the invention may comprise a barrier layer 68 proximate the display panel (see FIG. 3). The barrier layer 68 is configured to separate the image the user's left eye 70 sees (at the left eye pixels 74) and the image the user's right eye 72 sees (at the right eye pixels 76). This viewing separation (provided by the barrier layer 68) of the left eye and the right eye creates a three-dimensional effect for the user. For example, some other embodiments of the invention may comprise a lens layer 78 proximate the display panel (see FIG. 4). The lens layer 78 is also configured to separate the image the user's left eye 70 sees (at the left eye pixels 80) and the image the user's right eye 72 sees (at the right eye pixels 82). This viewing separation (provided by the lens layer 78) of the left eye and the right eye creates a three-dimensional effect for the user.

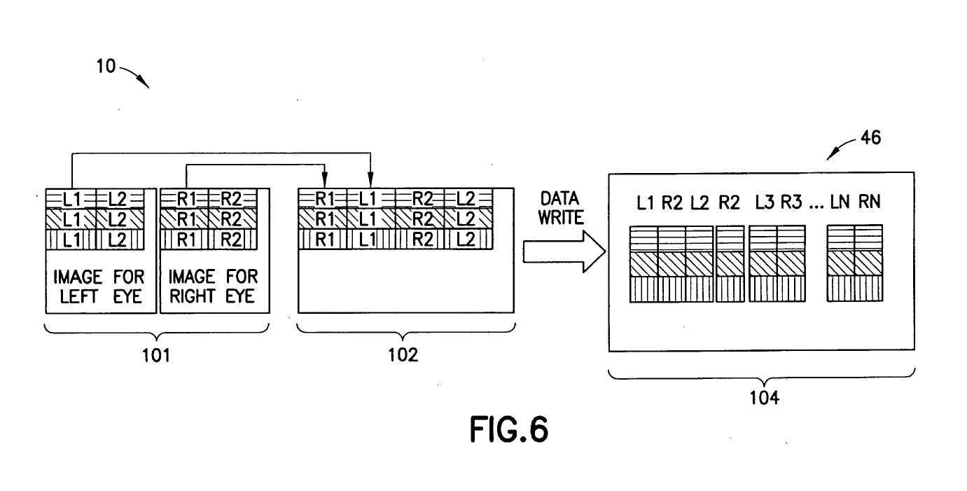

Referring now also to FIG. 5, there is shown an example according to some embodiments of the invention of how three-dimensional input data from the phone/device storage is mapped to the display memory 46. For example block 101 illustrates three-dimensional content as separate data in the phone storage, and block 102 illustrates three-dimensional content as combined data in the phone random access memory (RAM). In this embodiment, the data arrangement in the display memory 46 is provided as “LLLLLL . . . RRRRRR” (see block 103). However in some other alternate embodiments, the data arrangement in the display memory 46 may be provided as “LRLRLRLR . . . ” (see FIG. 6, block 104). However, any suitable data arrangement may be provided.

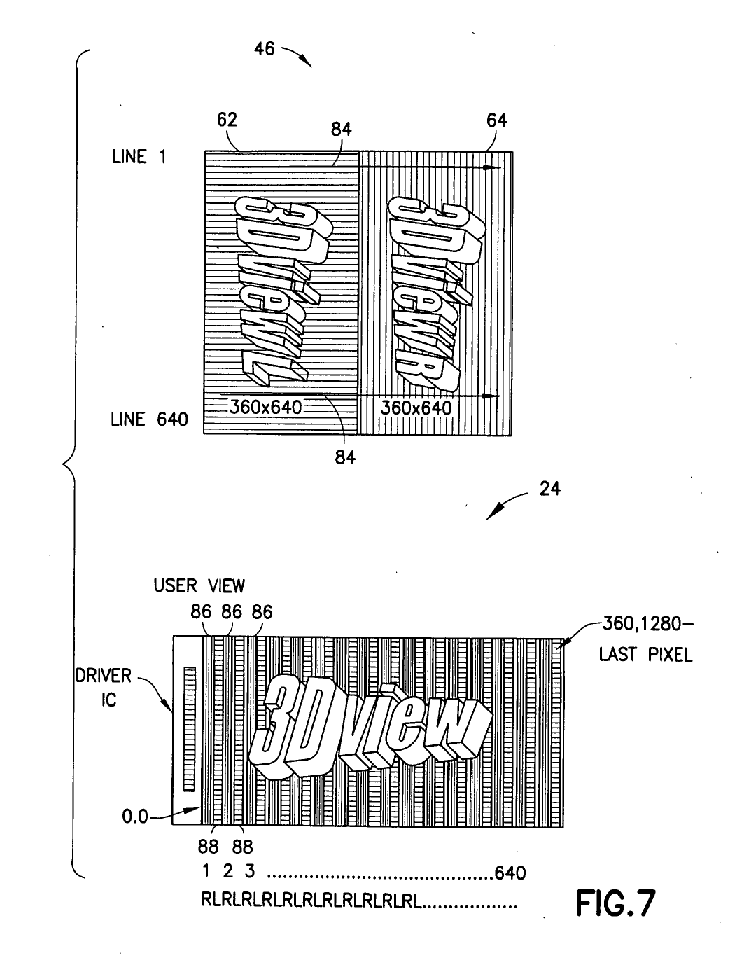

FIG. 7 illustrates how display RAM content (data) is generally mapped to the display panel 24. According to various exemplary embodiments of the invention, line based mapping is generally provided for the illustrated (RLRLR) columns on the display panel 24. Additionally, arrows 84 show how the display memory 46 is scanned to the display panel 24. For example, right eye data is on the red column 86, and left eye data on the blue column 88. According to some embodiments of the invention, the display memory 46 of the 3D display may be 360×640 pixels×2, wherein mapping is performed as “LLLLLL . . . RRRRRR . . . ” as shown in FIG. 5.

Still referring to FIG. 7, there is shown how the three-dimensional effect is provided for a user of the device 10. For example, the right eye of the user generally sees the information/image in the red columns 86, and the left eye of the user generally sees the information/image in the blue columns 88. However, it should be noted that one skilled in the art will appreciate that the various exemplary embodiments of the invention are not necessarily so limited and that different three-dimensional technologies may result in the order of the columns swapped. For example, lens and barrier type three-dimensional displays may have a different order for the right and left order. The information/image in the column 86 is different from the information/image in the column 88. This difference between the information/image creates a three-dimensional effect when viewed by the user at the display panel 24.

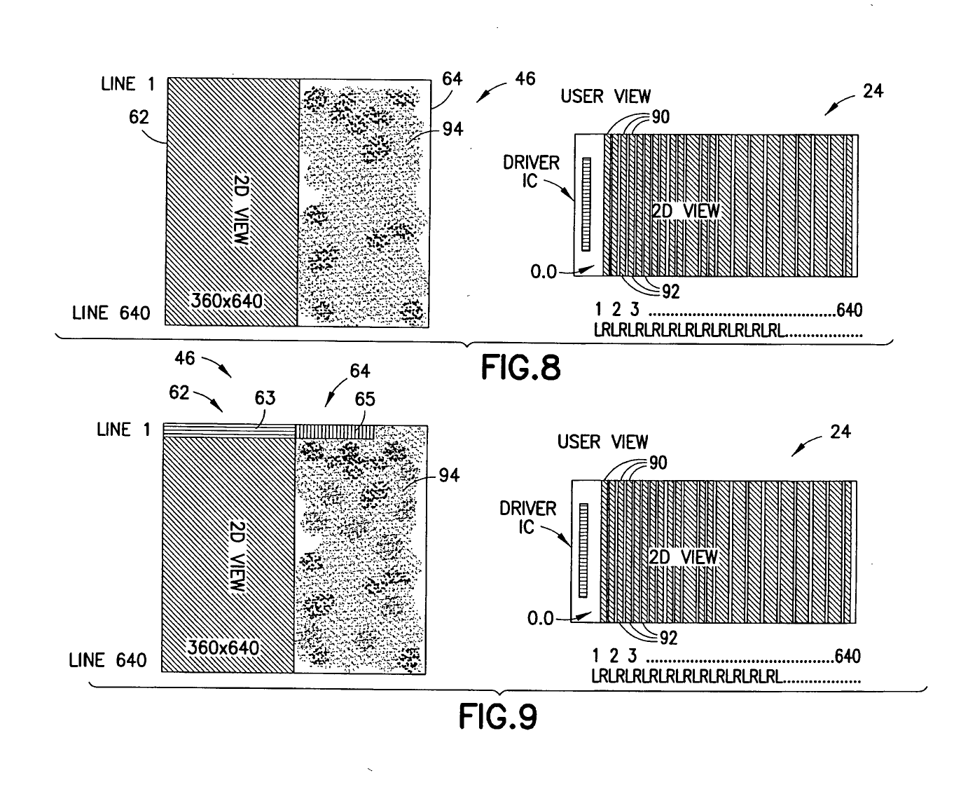

Referring now also to FIG. 8 there is shown one example of mapping two-dimensional RAM content to the display panel 24 and the display panel 24 displaying a traditional two-dimensional image. For example, the user can see the two-dimensional image when the left eye sees the same content as right eye. To do this, the display RAM (left eye frame memory 62, green color) content is automatically mapped copied to left and right pixels on the display screen (illustrated as ‘LRLR’ columns 90, 92 on the image). Alternatively, the left eye data 62 can be copied automatically to right eye 64 data side. As shown in FIG. 8, the right eye RAM content 64 is illustrated as random dots 94, representing invalid or random red, green, blue (RGB) data.

Referring now also to FIGS. 9-11 there is shown a method to remove image artifacts in three-dimensional display mode changes. For example, when the mode of the display is changed from a two-dimensional mode to a three-dimensional mode, various exemplary embodiments of the invention provide for data to be updated as simply as possible, without causing image artifacts on the display.

As described above for FIG. 8, in the two-dimensional mode, the display will generally map the RAM content of the left eye data 62 to left and right pixels (columns 90, 92). Or alternatively, the content of left eye RAM 62 is automatically copied to right eye RAM 64.

Still referring to FIG. 8, when entering the three-dimensional mode, the host provides an appropriate command (such as a “3D data input format” setting in display control register) to the display to make the display ready to receive three-dimensional data. When the “3D data input format” command is issued the display panel 24 continues copying left eye RAM data 62 to right panel columns 92 as in the two dimensional case (FIG. 8), and the display 24 continues operation normally as in 2D mode as it has not received the three-dimensional data yet.

Referring now to FIG. 9, as the host sends valid three-dimensional data to the display memory 46 (see blue line portion 63 and red line portion 65), initially the red line portion 65 has not been received completely. Thus the panel scanning continues as in the two-dimensional mode. For example, the display logical circuit waits for a proper amount of data (generally at least one left [or blue] line portion 63 and one right [or red] line portion 65) to be received from the host. Until that time, the display panel 24 keeps copying existing left pixel data 62 to the left and right pixels on panel (columns 90, 92), to avoid image artifacts.

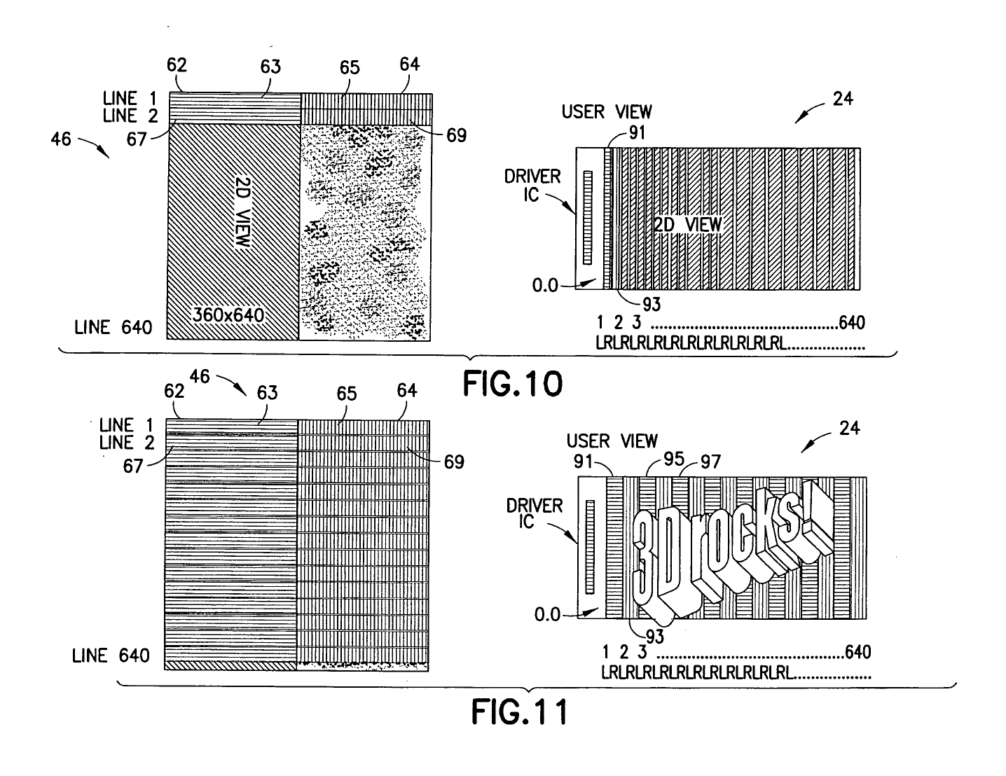

Referring now to FIG. 10, when the display module automatically detects it has received enough data to start three-dimensional scanning, it starts addressing pixels from left and right side RAM 62, 64 separately. For example, according to one embodiment of the invention, after receiving the first line of data (blue line portion 63 for left and red line portion 65 for right) successfully, the display automatically starts scanning left and right eye data to panel. The line portion 63 and the line portion 65 shown at the top of the display memory 46 form a combined data line, wherein the first line of (combined) data comprises the line portions 63, 65 (also shown as ‘line 1’ of the display memory 46). As shown the line portion 63 corresponds to the column 90, and the line portion 65 corresponds to the column 92. According to some exemplary embodiments of the invention, a simple electrical counter may be provided to track if enough data has been received.

It should be noted that according to another embodiment of the invention, after receiving the first lines of data 63, 65 ('line 1′ of the display memory 46) and second lines of data 67, 69 (also shown as ‘line 2’ of the display memory 46) successfully (instead of just the first line of data), the display automatically starts scanning left and right eye data to panel.

Referring now to FIG. 11, the process described above for FIG. 10 is continued and after all of the RAM content is scanned to the display panel 24, the user can see the three-dimensional image without artifacts. As shown, when the combined lines of data are received, the display panel 24 is updated with the three-dimensional image content. For example, the second line of data (shown as ‘line 2’) comprises line portions 67 (corresponding to column 95) and 69 (corresponding to column 97), and so forth (from ‘line 1’ to ‘line 640’).

According to some embodiments of the invention, exiting the three-dimensional mode may be performed in a similar manner, but vice versa. For example, until the proper amount of two-dimensional data is received to the display RAM, the display scans the left and right data in the three-dimensional mode to the panel. After proper amount of two-dimensional data is received, the display scans in the two-dimensional mode as described above for FIG. 8.

In some example embodiments of the invention, the display may include a “3D panel mode on” command, to enable some three-dimensional technology related features, such as the barrier layer shown in FIG. 3, or any other suitable optics features. Additionally, this may also be automated by logic. For example, the logic can detect if it has received the needed data and can then enable the barrier/logic circuitry automatically.

Technical effects of any one or more of the exemplary embodiments provide a method wherein the display can be on all the time. Thus, the software does not have to be so time-sensitive, when there is tendency to need to send three-dimensional data, the host (or engine) can send the “3D data input format”. Then after a random time, when the host updates the display RAM with the three-dimensional data, the display automatically maps the data correctly and starts addressing three-dimensional enabled display panel with left and right eye content.

According to various exemplary embodiments of the invention, the mode change from two-dimensional to three-dimensional (or vice versa) may be performed as follows: if at time t, the “3D data input format” register values are equal to time t−1, the display keeps the mode where it was. If at time t, the “3D data input format” register values are different to time t−1 and display RAM update has not been started, the display keeps the mode where it was. If at time t, the “3D data input format” register values are different to time t−1 and display RAM update has been started, the display waits until enough valid 3D data is received and updates the panel with valid data upon next refresh cycle.

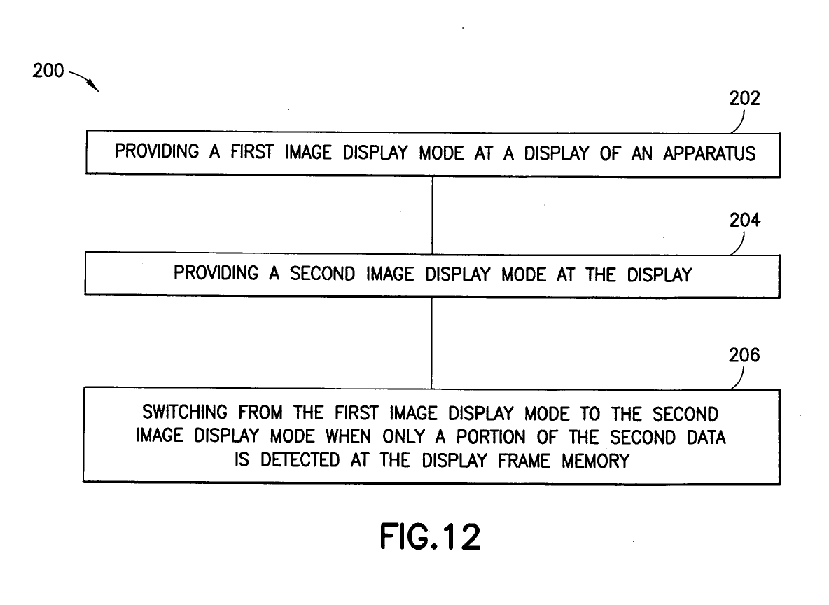

FIG. 12 illustrates a method to reduce two-dimensional to three-dimensional mode transition caused artifacts 200. The method 200 includes providing a first image display mode at a display of an apparatus, wherein the first image display mode comprises mapping first data from a display frame memory, wherein the first data corresponds to the first image display mode (at block 202). Providing a second image display mode at the display, wherein the second image display mode comprises mapping second data from the display frame memory, wherein the second data corresponds to the second image display mode (at block 204). Switching from the first image display mode to the second image display mode when only a portion of the second data is detected at the display frame memory (at block 206). It should be noted that the illustration of a particular order of the blocks does not necessarily imply that there is a required or preferred order for the blocks and the order and arrangement of the blocks may be varied. Furthermore it may be possible for some blocks to be omitted.

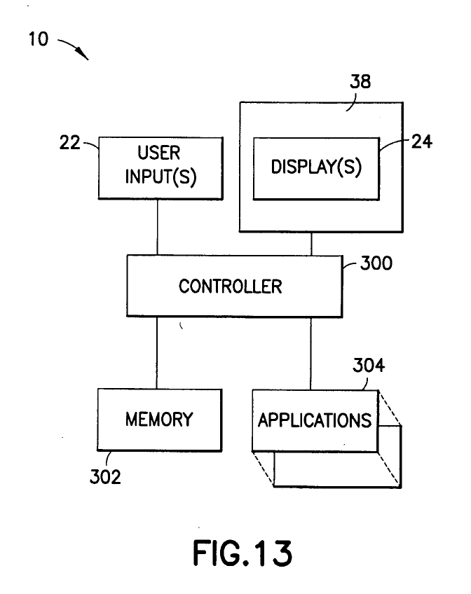

Referring now also to FIG. 13, the device 10 generally comprises a controller 300 such as a microprocessor for example. The electronic circuitry includes a memory 302 coupled to the controller 300, such as on a printed circuit board for example. The memory could include multiple memories including removable memory modules for example. The device has applications 304, such as software, which the user can use. The applications can include, for example, a telephone application, an Internet browsing application, a game playing application, a digital camera application, a map/gps application, for example. These are only some examples and should not be considered as limiting. One or more user inputs 22 are coupled to the controller 300. The display module 38 comprising the display panel 24 is also coupled to the controller 300 (which may be separate from or comprising the engine 36).

Various exemplary embodiments of the invention provide significant improvements over conventional configurations which use a simple “3D mode on” command. After receiving the “3D mode on” command, the display starts accessing panel separate left and right memory. The “3D mode on” command is easy to be given in incorrect timing as the display RAM generally does not have the correct data yet. For example, in the conventional configurations, when after the two-dimensional mode having been on, the right eye RAM can possibly have only random or incorrect data (such as the random/incorrect data 94 shown in FIG. 8), and after the “3D mode on” command is given, every column on the image shown in user view of the display panel (that should show content for right eye), could have incorrect or random data, and the display will have visible artifacts (the artifact will disappear when also correct right image data is written on to display).

Technical effects of any one or more of the exemplary embodiments provide a method to remove image artifacts in three-dimensional display related mode changes which provides various advantages when compared to conventional configurations which utilize image blanking time and make the mode change when display panel is not active, or shut down the display to avoid artifacts. For example, this can cause visible effects, and can also cause strong time dependency on the engine side, when the host needs to carefully monitor the right state of the display, to be able to switch from two-dimensional to three-dimensional mode, or vice versa. Additionally, some software approaches may be difficult, which can include long wait periods and difficult processes for sending phone three-dimensional content at the correct time, and then waiting for sync signal and enable three-dimensional mode.

Additional technical effects of any one or more of the exemplary embodiments provide for improved switching between two-dimensional and three-dimensional modes of the display module. For example, in conventional configurations problems generally occur when the display starts to show content in a three-dimensional mode and it has been earlier in a two-dimensional mode. Or vice versa, when the display has been showing a three-dimensional image and user wants to show a traditional two-dimensional image. In general, the problem during these mode changes is that during one frame, content is incorrect for left and right eye, if the mode change is not done correctly. This incorrect content can cause image artifacts or flashing, for example, on the display. Some conventional configurations may provide multiple sequential commands or simply blanking the display during the mode change. Whereas various exemplary embodiments of the invention provide for switching between two-dimensional and three-dimensional modes only after enough data corresponding to new mode is available, rendering images in the three-dimensional display without artifacts.

Further technical effects of various exemplary embodiments of the invention, provide for the display electronics to automatically recognize that it has received enough data to start showing the three-dimensional image (for example by using a counter circuit that calculates number of received data). The “3D data input format” command can be utilized very effectively if some additional logic is included in the display. When a new panel refresh cycle (refresh is marked with arrows 84 on FIG. 7, for example) is started, the display electronics will check “3D data input format” register. If register content is changed from two dimensional data format to three-dimensional data mode or vice versa, the display waits for enough valid data to be received and starts panel scanning automatically after it is sure that artifacts will not occur.

Without in any way limiting the scope, interpretation, or application of the claims appearing below, a technical effect of one or more of the example embodiments disclosed herein is a method of removing image artefacts when a display is switched from a two-dimensional mode to a three-dimensional mode and vice versa. The method includes recognizing presence of enough data in RAM before switching the display mode. The display renders image in previous mode if the RAM does not receive enough data corresponding to new mode. Another technical effect of one or more of the example embodiments disclosed herein is removing visual artifacts during mode change by automatically detecting when enough data has been received from the host, to make the mode change. Another technical effect of one or more of the example embodiments disclosed herein is utilizing a “3D data input format” setting in display control register (instead of simple a “3D mode on” command).

It should be understood that components of the invention can be operationally coupled or connected and that any number or combination of intervening elements can exist (including no intervening elements). The connections can be direct or indirect and additionally there can merely be a functional relationship between components.

As used in this application, the term ‘circuitry’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Embodiments of the present invention may be implemented in software, hardware, application logic or a combination of software, hardware and application logic. The software, application logic and/or hardware may reside on the device 10 or on a server. If desired, part of the software, application logic and/or hardware may reside on the device 10, and part of the software, application logic and/or hardware may reside on the server. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with examples of a computer described and depicted in FIGS. 2, 13. A computer-readable medium may comprise a computer-readable storage medium that may be any media or means that can contain or store the instructions for use by or in connection with an instruction execution system, apparatus, or device, such as a computer.

Below are provided further descriptions of various non-limiting, exemplary embodiments. The various aspects of one or more exemplary embodiments may be practiced in conjunction with one or more other aspects or exemplary embodiments. That is, the exemplary embodiments of the invention, such as those described immediately below, may be implemented, practiced or utilized in any combination (for example, any combination that is suitable, practicable and/or feasible) and are not limited only to those combinations described herein and/or included in the appended claims.

In one exemplary embodiment, a method to reduce two-dimensional to three-dimensional mode transition caused artifacts as above, wherein the first image display mode comprises a two dimensional display mode, and wherein the second image display mode comprises a three dimensional display mode.

A method as above, wherein the first data comprises two dimensional image data, and wherein the second data comprises three dimensional image data.

A method as above, wherein the first image display mode comprises a three dimensional display mode, and wherein the second image display mode comprises a two dimensional display mode.

A method as above, wherein the first data comprises three dimensional image data, and wherein the second data comprises two dimensional image data.

A method as above, wherein the switching from the first image display mode to the second image display mode when only a portion of the second data is detected at the display frame memory further comprises switching from the first image display mode to the second image display mode when only a first line of the second data is detected at the display frame memory.

A method as above, wherein the first data comprises only one of left eye or right eye display random access memory (RAM) content.

A method as above, wherein the second data comprises left eye and right eye display random access memory (RAM) content.

A method as above, wherein the switching further comprises switching from a two dimensional image display mode to a three dimensional image display mode after only a portion of valid three dimensional data is received.

A method as above, further comprising scanning the second data automatically to the display after the switching from the first image display mode to the second image display mode.

In another exemplary embodiment, an apparatus comprising: a display, at least one processor, and at least one memory. The display comprising a plurality of left display pixels and a plurality of right display pixels. The at least one memory including computer program code. The at least one memory and the computer program code configured to, with the at least one processor, cause the apparatus to perform at least the following. Map left eye memory data to the plurality of left display pixels and to the plurality of right display pixels. Detect a predetermined amount of combined data in the memory, wherein the combined data comprises the left eye memory data and right eye memory data. Address the plurality of left and right display pixels separately from the left eye memory data and from the right eye memory data in response to the detected predetermined amount of combined data.

An apparatus as above, wherein the predetermined amount of combined data comprises a single line of data.

An apparatus as above, wherein when the plurality of left and right display pixels are addressed separately, the left eye memory data corresponds to a column of the left display pixels and the right eye memory data corresponds to a column of the right display pixels.

An apparatus as above, wherein the at least one memory and the computer program code configured to, with the at least one processor, cause the apparatus to detect the determined amount of combined data in the memory in response to a “3D data input format” command.

An apparatus as above, wherein the apparatus further comprises an electrical counter configured to count the combined data in the memory.

An apparatus as above, wherein the apparatus comprises a mobile phone.

In another exemplary embodiment, a computer program product comprising a computer-readable medium bearing computer program code embodied therein for use with a computer, the computer program code comprising: code for accessing only a first portion of data in a memory, wherein the first portion of data is configured to be mapped to left display pixels and to right display pixels of a display. Code for calculating an amount of combined data received in the memory, wherein the combined data comprises the first portion of the data and a second portion of the data. Code for addressing the left and right display pixels separately from the first and the second portions of the data after a predetermined amount of the combined data is received.

A computer program product as above, wherein the first portion of data comprises left eye display random access memory (RAM) content and wherein the second portion of the data comprises right eye display RAM content.

A computer program product as above, wherein the combined data comprises three dimensional image data.

A computer program product as above, wherein the predetermined amount of the combined data comprises one line of data.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. A method, comprising:
providing a first image display mode at a display of an apparatus, wherein the first image display mode comprises mapping first data from a display frame memory, wherein the first data corresponds to the first image display mode;
providing a second image display mode at the display, wherein the second image display mode comprises mapping second data from the display frame memory, wherein the second data corresponds to the second image display mode; and
switching from the first image display mode to the second image display mode when only a portion of the second data is detected at the display frame memory.

2. A method as in claim 1 wherein the first image display mode comprises a two dimensional display mode, and wherein the second image display mode comprises a three dimensional display mode.

3. A method as in claim 1 wherein the first data comprises two dimensional image data, and wherein the second data comprises three dimensional image data.

4. A method as in claim 1 wherein the first image display mode comprises a three dimensional display mode, and wherein the second image display mode comprises a two dimensional display mode.

5. A method as in claim 1 wherein the first data comprises three dimensional image data, and wherein the second data comprises two dimensional image data.

6. A method as in claim 1 wherein the switching from the first image display mode to the second image display mode when only a portion of the second data is detected at the display frame memory further comprises switching from the first image display mode to the second image display mode when only a first line of the second data is detected at the display frame memory.

7. A method as in claim 1 wherein the first data comprises only one of left eye or right eye display random access memory (RAM) content.

8. A method as in claim 1 wherein the second data comprises left eye and right eye display random access memory (RAM) content.

9. A method as in claim 1 wherein the switching further comprises switching from a two dimensional image display mode to a three dimensional image display mode after only a portion of valid three dimensional data is received.

10. A method as in claim 1 further comprising scanning the second data automatically to the display after the switching from the first image display mode to the second image display mode.

11. An apparatus, comprising:
a display comprising a plurality of left display pixels and a plurality of right display pixels;
at least one processor; and
at least one memory including computer program code
the at least one memory and the computer program code configured to, with the at least one processor, cause the apparatus to perform at least the following:
map left eye memory data to the plurality of left display pixels and to the plurality of right display pixels;
detect a predetermined amount of combined data in the memory, wherein the combined data comprises the left eye memory data and right eye memory data; and
address the plurality of left and right display pixels separately from the left eye memory data and from the right eye memory data in response to the detected predetermined amount of combined data.

12. An apparatus as in claim 11 wherein the predetermined amount of combined data comprises a single line of data.

13. An apparatus as in claim 11 wherein when the plurality of left and right display pixels are addressed separately, the left eye memory data corresponds to a column of the left display pixels and the right eye memory data corresponds to a column of the right display pixels.

14. An apparatus as in claim 11 wherein the at least one memory and the computer program code configured to, with the at least one processor, cause the apparatus to detect the determined amount of combined data in the memory in response to a “3D data input format” command.

15. An apparatus as in claim 11 wherein the apparatus further comprises an electrical counter configured to count the combined data in the memory.

16. An apparatus as in claim 11 wherein the apparatus comprises a mobile phone.

17. A computer program product comprising a computer-readable medium bearing computer program code embodied therein for use with a computer, the computer program code comprising:
code for accessing only a first portion of data in a memory, wherein the first portion of data is configured to be mapped to left display pixels and to right display pixels of a display;
code for calculating an amount of combined data received in the memory, wherein the combined data comprises the first portion of the data and a second portion of the data; and
code for addressing the left and right display pixels separately from the first and the second portions of the data after a predetermined amount of the combined data is received.

18. A computer program product as in claim 17 wherein the first portion of data comprises left eye display random access memory (RAM) content and wherein the second portion of the data comprises right eye display. RAM content.

19. A computer program product as in claim 17 wherein the combined data comprises three dimensional image data.

20. A computer program product as in claim 17 wherein the predetermined amount of the combined data comprises one line of data.
